(19) United States
(12) Patent Application Publication
(10) Pub. No.: US 2015/0278383 A1
(43) Pub. Date: Oct. 1, 2015

(54) METHOD AND TERMINAL FOR PROVIDING SEARCH-INTEGRATED NOTE FUNCTION

(71) Applicant: Samsung Electronics Co., Ltd., Suwon-si (KR)

(72) Inventors: Seok Jin Hong, Hwaseong-si (KR); Yo Han Roh, Hwaseong-si (KR); Kyoung Gu Woo, Seoul (KR); Sang Hyun Yoo, Seoul (KR); Ji Hyun Lee, Hwaseong-si (KR); Ho Dong Lee, Yongin-si (KR)

(73) Assignee: Samsung Electronics Co., Ltd., Suwon-si (KR)

(21) Appl. No.: 14/668,241

(22) Filed: Mar. 25, 2015

(30) Foreign Application Priority Data
Mar. 31, 2014 (KR) 10-2014-0038072

(51) Int. Cl. G06F 17/30

(52) U.S. Cl. CPC G06F 17/30882; G06F 17/30864

(57) ABSTRACT

A method of providing a search-integrated note function includes selecting a part of a text recorded in a note; performing a web search with regard to the selected text; clipping data selected by a user from a web search result; linking the clipped data to the selected text; and storing the clipped data.

### CROSS-REFERENCE TO RELATED APPLICATIONS

This application claims the benefit under 35 USC 119(a) of Korean Patent Application No. 10-2014-0038072 filed on Mar. 31, 2014, in the Korean Intellectual Property Office, the entire disclosure of which is incorporated herein by reference for all purposes.

### BACKGROUND

1. Field

The following description relates to a method and terminal for providing a search-integrated note function.

2. Description of Related Art

With the widespread dissemination of portable smart devices, such as a smartphone and a tablet PC, the portable smart devices have been enabled to perform a lot of tasks previously performed in a PC. Thus, although a user is able to enjoy the convenience of accessing desired information and performing desired tasks anytime and anywhere, there is a limit to smoothly performing complicated PC-level tasks due to display size and input limit of the portable smart device.

For example, for finding information through web searches on a PC, various web browser windows can be simultaneously launched to conveniently browse and search for desired information that can be easily saved by copying and pasting the desired information on a wide screen with a keyboard/mouse-based convenient input in a PC. However, for small smart devices, such as a smartphone, the task of launching various web browser windows at the same time and copying and pasting desired information are still difficult and inconvenient.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of providing a search-integrated note function includes selecting a part of a text recorded in a note; performing a web search with regard to the selected text; clipping data selected by a user from a web search result; linking the clipped data to the selected text; and storing the clipped data.

The performing of the web search may include performing the web search using the selected text as a main search word and using at least one adjacent text of the selected text as an assistant search word.

The adjacent text may be a text recorded on the same note as the selected text.

The performing of the web search may include requesting a web server to perform the web search with respect to the selected text; and receiving the web search result from the web server.

The method may further include displaying the web search result on an area of a note screen.

The method may further include searching, in response to a concept expansion command, one or more subordinate concepts with respect to the selected text; and inserting the one or more searched subordinate concepts into the note.

The searching of the one or more subordinate concepts may include searching the one or more subordinate concepts based on an ontology built in advance.

The inserting of the one or more searched subordinate concepts into the note may include inserting, into the note, one or more subordinate concepts selected by the user from the one or more searched subordinate concepts.

In another general aspect, a terminal include a text selector configured to select a part of text recorded in a note; a searcher configured to perform a web search with respect to the selected text; a clipper configured to clip data selected by a user from a web search result; a storage configured to store the clipped data; and a note integrator configured to link the clipped data to the selected text and store the clipped data.

The searcher may be further configured to perform the web search using the selected text as a main search word and using at least one adjacent text of the selected text as an assistant search word.

The adjacent text may be a text recorded in the same note as the selected text.

The searcher may be further configured to perform the web search by requesting a web server to perform the web search with respect to the selected text, and receiving the web search result from the web server.

The terminal may further include a display configured to display a note screen; and the searcher may be further configured to display the web search result on an area of the note screen through the display.

The searcher may be further configured to search, in response to a concept expansion command, one or more subordinate concepts with regard to the selected text; and the note integrator may be further configured to insert the one or more searched subordinate concepts into the note.

The searcher may be further configured to search, in response to the concept expansion command, the one or more subordinate concepts based on an ontology built in advance.

The note integrator may be further configured to insert, into the note, one or more subordinate concepts selected by the user from the one or more searched subordinate concepts.

Other features and aspects will be apparent from the following detailed description, the drawings, and the claims.

### BRIEF DESCRIPTION OF THE DRAWINGS

FIG. 1 illustrates an example of a terminal.

FIG. 2 illustrates an example of a controller.

FIG. 3A illustrates an example of selecting a text that a user intends to use for a web search from texts saved in a note.

FIG. 3B illustrates an example of displaying a menu for selecting one of a web search function and a concept expansion function.

FIG. 3C illustrates an example of a result of performing a web search according to a selection of a web search function on a note screen.

FIG. 3D illustrates an example of clipping a part of data from a web search result.

FIG. 3E illustrates an example of integrating clipped data in a note.

FIG. 4A illustrates an example of displaying a subordinate concept search result in a note in response to a concept expansion function selection.

FIG. 4B illustrates an example of integrating a subordinate concept search result in a note.

FIG. 5 illustrates an example of using a text around a search word in a web search.

FIG. 6 illustrates a method of providing a search-integrated note function.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The leftmost digit or digits of a reference numeral identify the figure in which the reference numeral first appears. The drawings may not be to scale, and the relative size, proportions, and depiction of elements in the drawings may be exaggerated for clarity, illustration, and convenience.

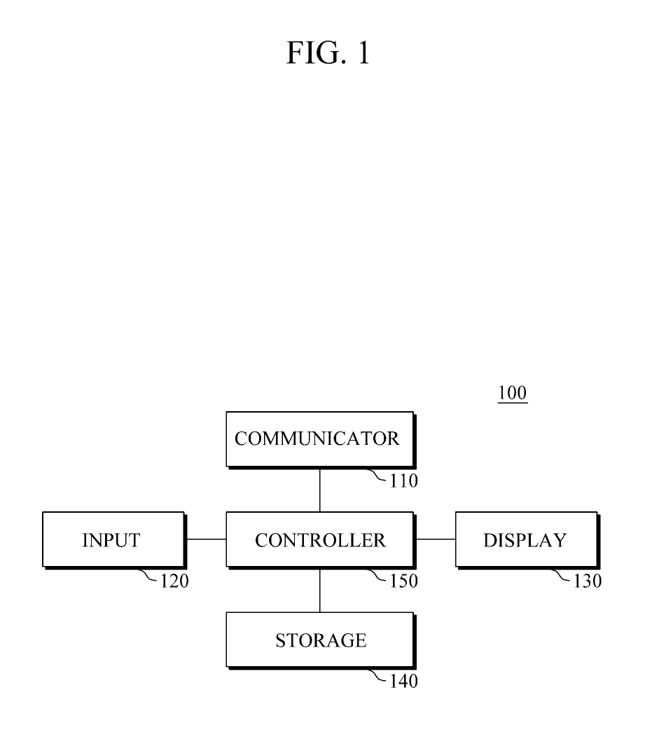

FIG. 1 illustrates an example of a terminal.

A terminal in this example is a device having a function (hereinafter referred to as ‘a search-integrated note function’) for selecting and searching a part of a note intended to be searched and for integrating and saving a part of a search result intended to be saved in a note through a simple selection process without executing a web browser or a search application in a case where a search is needed while a note is being made, wherein the terminal may be a mobile terminal or a fixed terminal. The mobile terminal may be a mobile phone, a smartphone, a tablet, a PC, a laptop computer, a terminal for digital broadcasting, a Personal Digital Assistant (PDA), a Portable Multimedia Player (PMP), a navigation, or any other type of mobile terminal known to one of ordinary skill in the art, and the fixed terminal may be a digital TV, a smart TV, a desktop computer, or any other type of fixed terminal known to one of ordinary skill in the art.

In the following description, a smartphone is described as one example of a mobile terminal for convenience of description.

Referring to FIG. 1, a terminal 100 includes a communicator 110, an input 120, a display 130, a storage 140, and a controller 150.

The communicator 110 transmits and receives data to and from other devices through wired or wireless networks, such as a wireless internet, a wireless intranet, a wireless telephone network, a wireless local area network (LAN) Wi-Fi® network, a Wi-Fi direct (WFD) network, a 3G network, a 4G Long Term Evolution (LTE) network, a Bluetooth network, an Infrared Data Association (IrDA) network, a Radio Frequency Identification (RFID) network, an Ultra Wide Band (UWB) network, a Zigbee network, a Near Field Communication (NFC) network, or any other network known to one of ordinary skill in the art To this end, the communicator 110 includes a mobile communication module, a wireless internet module, a wired internet module, a Bluetooth module, an NFC module, or any other communication module known to one of ordinary skill in the art.

The input 120 receives various control signals from a user and generates input data for controlling an operation of the terminal 100. For example, the input 120 may include a keypad, a dome switch, a touchpad (resistive/capacitive), a jog wheel, a jog switch, an H/W button, or any other device for inputting a control signal known to one of ordinary skill in the art.

In particular, as described below, in a case where a touchpad is in a mutually layered form with the display 130, the touchpad may be called a touchscreen.

The display 130 displays information processed in the terminal 100. For example, the display 130 may display a User Interface (UI) or a Graphical User Interface (GUI).

The display 130 may include a Liquid Crystal Display (LCD) display, a Thin Film Transistor LCD (TFT-LCD) display, an Organic Light Emitting Diode (OLED) display, a flexible display, a 3-dimensional display, or any other type of display known to one of ordinary skill in the art.

Also, two or more displays 130 may be provided according to an implementation form of the terminal 100. For example, the terminal 100 may include a plurality of the displays 130 that are disposed separately on one side, or disposed in one body, or disposed on different sides.

The display 130 may be in a mutually layered form with the touchpad to implement a touchscreen, and in this case, the display 130 may be used as an input device as well as an output device.

The storage 140 stores programs and instructions for operations of the controller 150, and also stores data that is input/output.

The storage 140 may include flash memory type memory, hard disk type memory, multimedia card micro type memory, a card type memory (e.g., SD or XD memory), Random Access Memory (RAM), Static Random Access Memory (SRAM), Read Only Memory (ROM), Electrically Erasable Programmable Read Only Memory (EEPROM), Programmable Read Only Memory (PROM), magnetic memory, a magnetic disc, an optical disk, or any other type of storage known to one of ordinary skill in the art. Also, the terminal 100 may operate an external storage medium, such as web storage that performs a storage function of the storage 140 on the internet.

The controller 150 controls an overall operation of the terminal 100. The controller 150 performs each function of the terminal 100 in response to input signals that are input from the input 120, and displays information on a function performance state and a function performance result, etc., through the display 130.

The controller 150 displays a note screen on the display 130 in response to a search-integrated note function executing signal that is input from the input 120, and saves, in the note, a text corresponding to a text input signal that is input from the input 120.

In addition, the controller 150 may perform a web search function and/or a concept expansion function. The web search function is a function of performing the web search with respect to a specific text and inserting the result into the note; and the concept expansion function is a function of searching subordinate concepts with respect to the specific text and inserting the result into the note. For example, the controller 150 may select a part of the text from the texts saved in the note, perform the web search with respect to the selected text, and display the result on an area of the note screen (the web search function), or search the subordinate concepts with respect to the selected text and insert the result into the note (the concept expansion function).

Moreover, the controller 150 may receive a clip instruction from the input 120, selects and clips the entire web search result or some part or parts of the web search result, and inserts the clipped data into the note, or links the clipped data to the specific text used as the search word to store the clipped data in the storage 140.

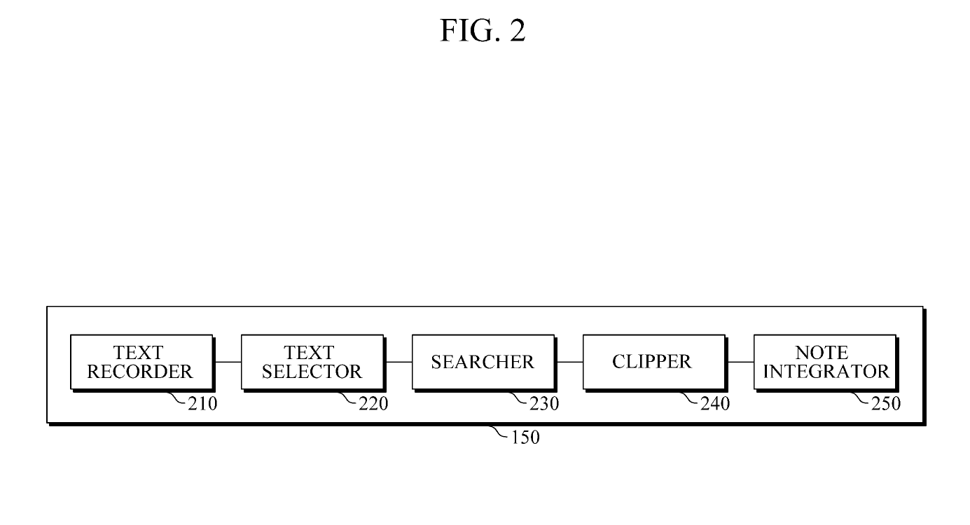

FIG. 2 illustrates an example of a controller.

Referring to FIGS. 1 and 2, a controller 150 includes a text recorder 210, a text selector 220, a searcher 230, a clipper 240, and a note integrator 250.

The text recorder 210 receives a text record signal from an input 120 and records a text corresponding to the text record signal in a note.

The text selector 220 receives a text selecting signal from the input 120 and selects a part of the text recorded in the note. For example, the text selector 220 detects generation of a touch, a drag, and a touch input with regard to a part of the text recorded in the note, wherein the touch input is input in a closed curve form, such as a circle. Then, the text selector 220 selects the corresponding text.

The text selector 220 may apply various effects to the selected text, such as a shading process, a color change, an underline insertion, a thickness adjustment, and other effects known to one of ordinary skill in the art, so that the selected text is distinguished from another text.

The searcher 230 performs a web search with respect to the text selected by the text selector 220 and displays the result on a partial area of a note screen.

In one example, the searcher 230 performs the web search using, as a search word, only the text selected by the text selector 220. For example, the searcher 230 performs the web search using, as a target, only the text selected by the text selector 220 without considering an external context.

In another example, the searcher 230 uses, as a main search word, the text selected by the text selector 220 and performs the web search using, as an assistant search word, a surrounding text or adjacent text that exists around the selected text. The surrounding text or the adjacent text may be text recorded in the same note as the selected text.

Thus, the terminal 100 may discern a user's search intention and a context based on the surrounding text that exists around the search word to enable performance of an elaborate search.

In another example, the searcher 230 supplements the search word using the external context, such as a location, present time, or other external content of the terminal 100 as well as the text selected by the text selector 220 and the surrounding text of the selected text.

In yet another example, the searcher 230 performs the web search by accessing a web server that exists outside the terminal 100. That is, the searcher 230 transmits a request for the web search with respect to the text selected by the text selector 220 to the web server that exists outside the terminal 100 through the communicator 110 and receives the web search result from the web server. In this case, the web server receives the web search request from the terminal 100, performs the web search with respect to the text that has been received together with the web search request, and transmits the result to the searcher 230 through the communicator 110.

Accordingly, the terminal 100 may perform the web search without executing an additional web browser or a search program.

In addition, when receiving a concept expansion function executing signal from the input 120, the searcher 230 searches the subordinate concepts with respect to a concept of the selected text by the text selector 220 and displays the result on an area of the note screen. The searcher 230 may search the subordinate concepts of the selected text based on an ontology in which the concepts are hierarchically structured. The ontology may be built in advance in the terminal 100 or in an external server of the terminal 100.

In a case where the ontology is built in advance in the external server of the terminal 100, the searcher 230 communicates with the external server through the communicator 110. That is, the searcher 230 transmits a request for the subordinate concept search with respect to the selected text to the external server through the communicator 110 and receives the subordinate concept search result from the external server. In this case, the external server receives the request for the subordinate concept search from the terminal 100, searches the subordinate concepts of the text that is received together with the request for the subordinate concept search based on the ontology built in advance, and transmits the result to the searcher 230 through the communicator 110.

In one example, the searcher 230 provides a user with a menu for selecting one of a web search function and a concept expansion function. At this time, the menu may be displayed on an area of the note screen.

The clipper 240 receives a data clipping signal from the input 120 and clips data selected by the user from the web search result.

For example, the clipper 240 detects generation of a touch input, which is input in a closed curve form, such as a circle, with respect to some parts of the web search result displayed on an area of the note screen, and clips the relevant data. Although the touch input, which is input in a closed curve form, such as a circle, has been described as one example of a method for determining a clip object and a clip range, this example is not limited thereto.

The note integrator 250 integrates the clipped data from the clipper 240 in the note. For example, the note integrator 250 links the data clipped by the scrapper 240 to the text selected by the text selector 220 and stores the clipped data. In another example, the note integrator 250 inserts, into the note, the entire content of the data clipped by the clipper 240.

In addition, the note integrator 250 integrates, in the note, the subordinate concepts that have been searched by the searcher 230 in response to the concept expansion function executing signal. For example, the note integrator 250 inserts, into the note, the searched subordinate concepts in a graph form or in an indentation form.

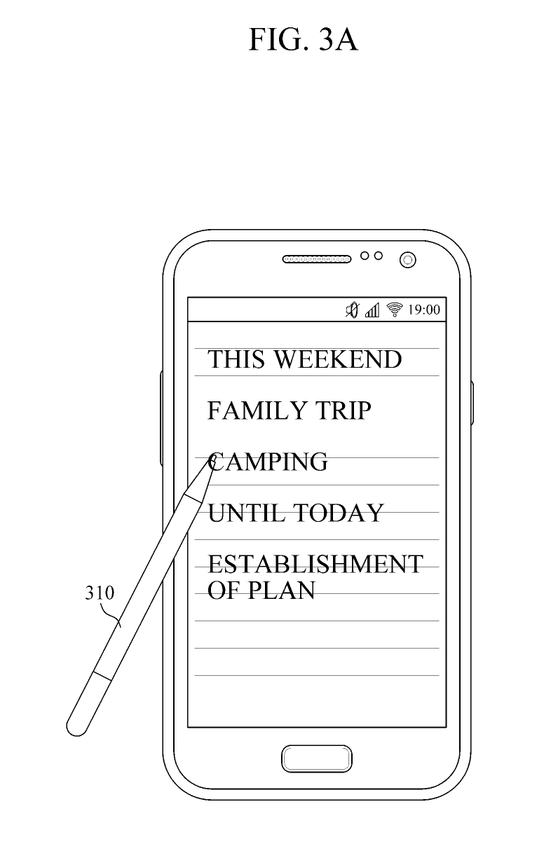

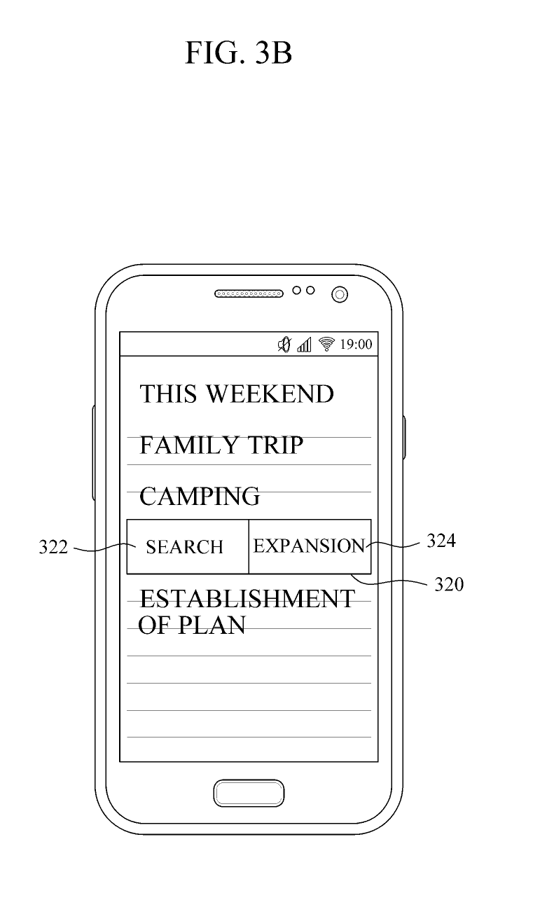

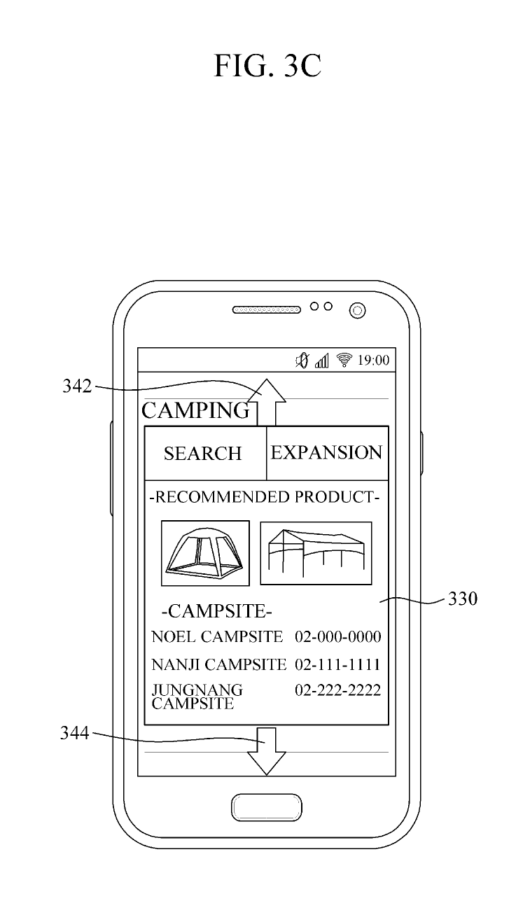

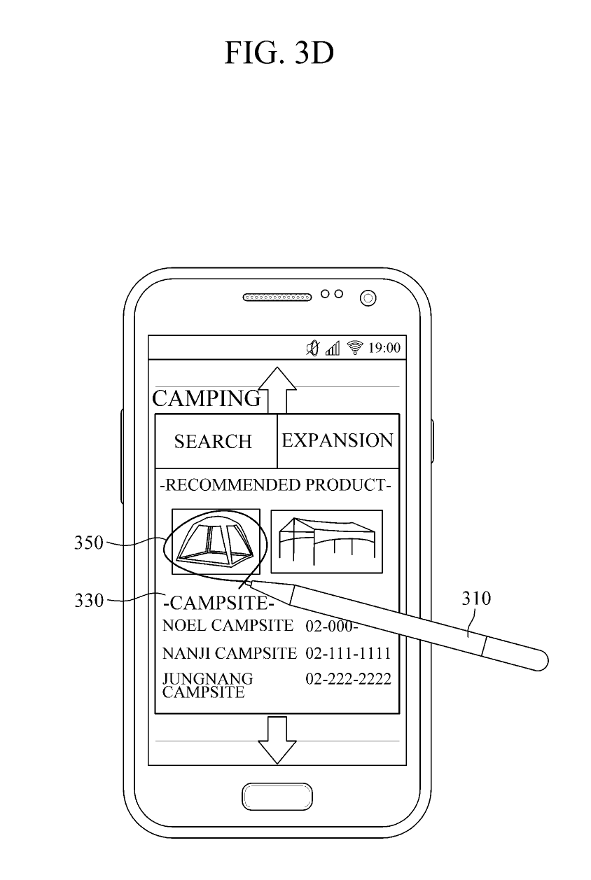

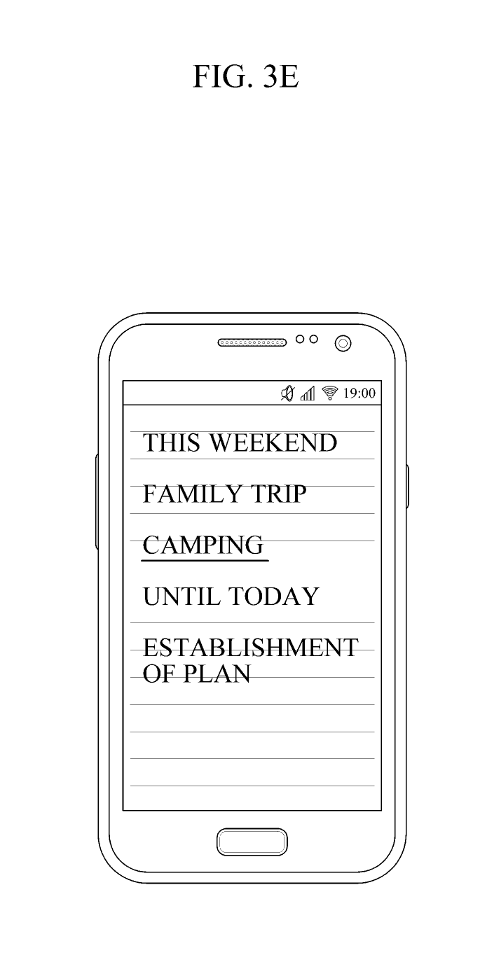

FIGS. 3A to 3E illustrate examples of a web search function. More specifically, FIG. 3A illustrates an example of selecting a text, from texts saved in a note, that a user intends to use for a web search from texts saved in a note; FIG. 3B illustrates an example of displaying a menu for selecting one of a web search function and a concept expansion function; FIG. 3C illustrates an example of a result of performing a web search according to a selection of a web search function on a note screen; FIG. 3D illustrates an example of clipping a part of data from a web search result; and FIG. 3E illustrates an example of integrating clipped data in a note.

Referring to FIGS. 2 and 3A, if a user selects a text ‘camping’ in the text saved in a note using a stylus pen 310 when ‘this weekend’, ‘family trip’, ‘camping’, ‘until today’, and ‘establishment of plans’ are written on a note, the text selector 220 selects the text ‘camping’ as a search target text.

Referring to FIGS. 2 and 3B, the searcher 230 displays, on an area of a note screen, a menu 320 to select one of a web search function for performing a web search and a concept expansion function for searching and inserting subordinate concepts with respect to the text ‘camping’.

Referring to FIGS. 2 and 3C, in a case where the user selects a search 322 from the menu 320 to perform the web search function, the searcher 230 performs the web search with respect to ‘camping’ without executing a web browser or a search program and displays a result 330 on an area of the note screen. The web search result 330 displayed on an area of the note screen may be moved up and down on the note by clicking or selecting movement icons 342 and 344.

Although FIG. 3C illustrates an example of the web search result 330 moved up and down, this example is not limited thereto, and the web search result 330 may be moved in various directions according to a position where the web search result 330 is shown on the note screen.

Referring to FIGS. 2 and 3D, if the user selects data 350 to be clipped from the web search result 330 displayed on an area of the note screen using the stylus pen 310, the clipper 240 clips the data 350 that the user has selected.

Referring to FIGS. 2 and 3E, if the clipping of the data 350 is completed in the clipper 240, the note integrator 250 links the clipped data 350 to the text ‘camping’ saved in a note and stores the clipped data 350 in storage 140. Here, although FIG. 3E illustrates an example of an underline mark as a link mark indicating that the clipped data has been integrated with the note, this example is not limited thereto, and various effects may be applied as a link mark, such as a shading process, a color change, a thickness adjustment, or any other effect capable of acting as a link known to one of ordinary skill in the art. When a user later clicks on the text ‘camping’ with the link mark, the clipped data 350 that was integrated with the note will be retrieved from the storage 140 and displayed on an area of the note screen.

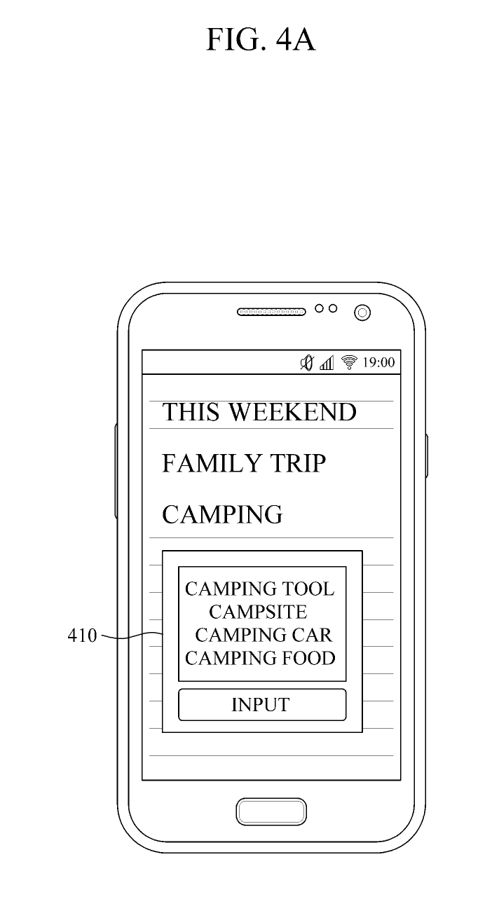

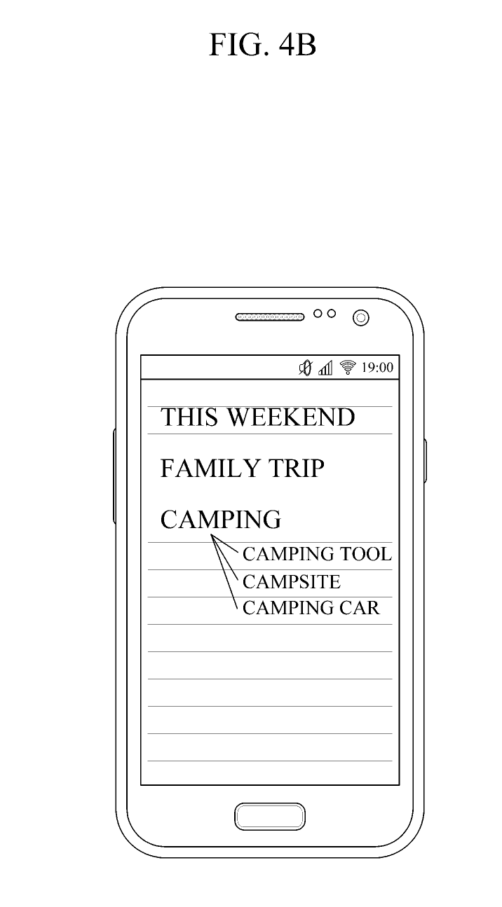

FIGS. 4A and 4B illustrate examples of a concept expansion function. More specifically, FIG. 4A illustrates an example of displaying a subordinate concept search result in a note in response to a concept expansion function selection, and FIG. 4B illustrates an example of integrating a subordinate concept search result in a note.

Referring to FIGS. 2, 4A, and 3B, if the user selects the expansion 324 from the menu 320 to perform a concept expansion function, the searcher 230 searches camping tools, campsites, camping cars, and camping food as subordinate concepts of camping based on an ontology in which concepts are hierarchically structured, and displays the subordinate concept search result 410 on an area of the note.

Referring to FIGS. 2 and 4B, in a case where the user selects camping tools, campsites, and camping cars to expand the concept from the searched subordinate concepts (camping tools, campsites, camping cars, and camping food), the note integrator 250 inserts the camping tools, the campsites, and the camping cars into the note as the subordinate concepts of camping.

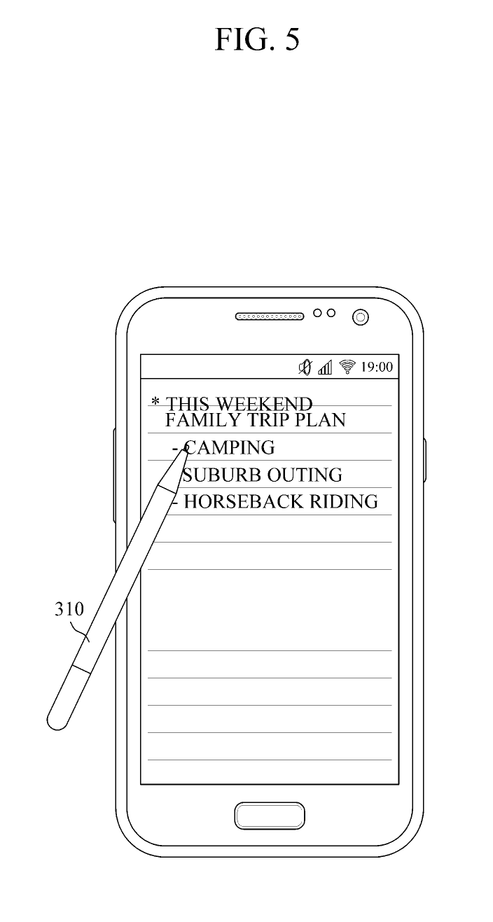

FIG. 5 illustrates an example of using a text around a search word in a web search.

Referring to FIGS. 2 and 5, if ‘this weekend family trip plan’, ‘camping’, ‘suburb outing’, and ‘horseback riding’ are written on a note and a user selects the text ‘camping’ from the texts recorded in the note using the stylus pen 310, the searcher 230 performs a web search using the text ‘camping’ as a main search word and using, as assistant search words, ‘weekend’, ‘family’ ‘suburb’, ‘outing’, and ‘horseback riding’ that are surrounding texts of the text ‘camping’.

Thus, the terminal 100 may discern a more precise context of the search to provide a search result more appropriate to the user's intention.

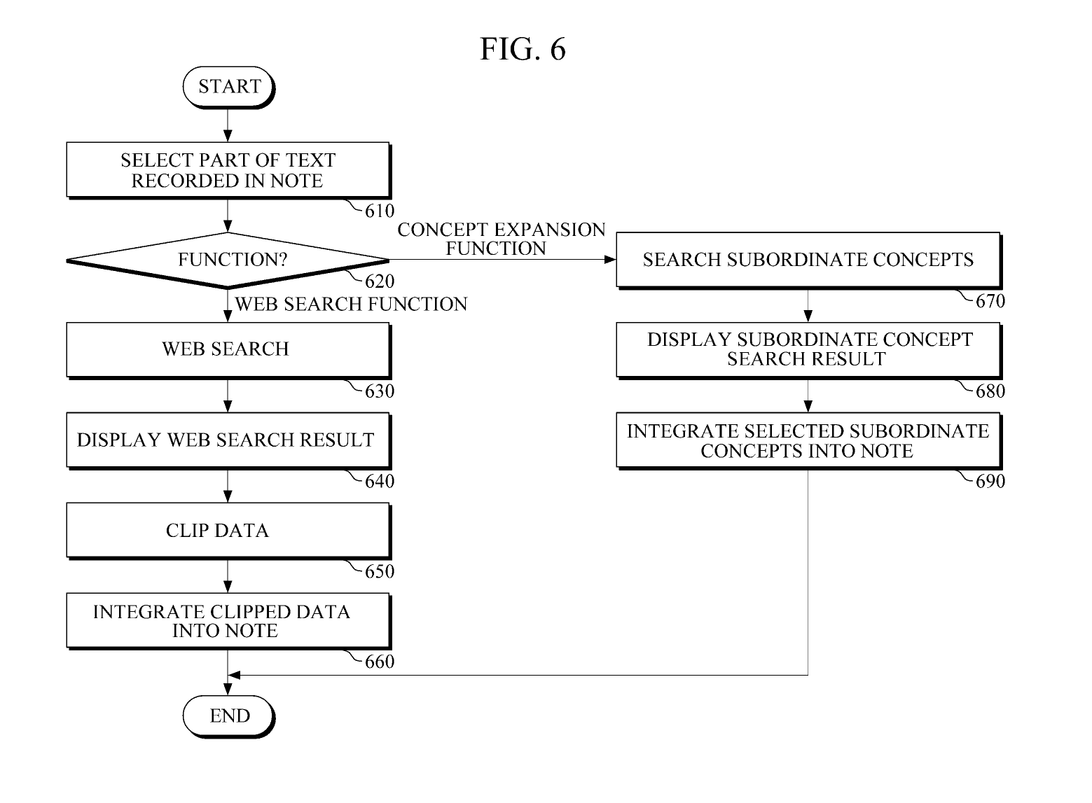

FIG. 6 illustrates an example of a method of providing a search-integrated note function.

Referring to FIGS. 1, 2, and 6, a method of providing a search-integrated note function comprises first selecting a part of text recorded in the note in 610. For example, the terminal 100 detects generation of a touch, a drag, and a touch input with regard to the part of the text recorded in the note, wherein the touch input is input in a closed curve form, such as a circle. Then, the terminal 100 selects the corresponding text.

The terminal 100 may apply various effects to the selected text, such as a shading process, a color change, an underline insertion, a thickness adjustment, or any other effect known to one of ordinary skill in the art, so that the selected text is distinguished from unselected texts.

Afterwards, the terminal 100 determines whether there is an input for performing a web search function or an input for performing a concept expansion function with respect to the selected text in 620. For example, the terminal 100 displays, on an area of a note screen, a menu for selecting one of the web search function and the concept expansion function, and using the menu, determine whether the user's input is the input for performing the web search function or the input for performing the concept expansion function.

In a case where the result of the determination in operation 620 is that there is an input for performing a web search function, the terminal 100 performs the web search with respect to the text selected in operation 610 in 630. For example, the terminal 100 detects the input for performing a web search function, accesses a predetermined web server, and performs the web search with respect to the selected text. That is, the terminal 100 transmits a request for the web search with respect to the selected text to a web server that exists outside the terminal 100 and receives a web search result from the web server.

The terminal 100 may perform the web search using only the selected text as a search word without considering an external context. Also, the terminal 100 may perform the web search using the selected text as a main search word and using, as an assistant search word, a surrounding text or an adjacent text that exists around the selected text. In addition, the terminal 100 may supplement the search word using the external context, such as a location and a local time of the terminal 100, as well as the selected text and its surrounding text.

Afterwards, the terminal 100 displays the web search result on an area of a note screen in 640. The terminal 100 may display icons for moving the web search result up, down, left, and right.

Afterwards, if a data clipping command regarding specific data in the web search result is input by the user, the terminal 100 clips the corresponding data in 650. For example, the clipper 240 detects generation of a touch input that is input in a closed curve form, such as a circle, with regard to the entire web search result or a part of the web search result, and clips the entire web search result or the part of the web search result.

Afterwards, the terminal 100 integrates the data into the note in 660. For example, the terminal 100 links the clipped data to the selected text, stores the clipped data, and inserts the entire content of the clipped data into the note.

On the other hand, in a case where the result of the determination in operation 620 is that there is an input for performing a concept expansion function, the terminal 100 searches subordinate concepts of the concept with respect to the text selected in operation 610 in 670.

For example, the terminal 100 searches the subordinate concepts with respect to the concept of the selected text based on an ontology in which the concepts are hierarchically structured. The ontology may be built in advance in the terminal 100 or in an external server of the terminal 100.

In a case where the ontology is built in advance in the external server of the terminal 100, the terminal 100 sends a subordinate concept search request with respect to the selected text to the external server, and receives the subordinate concept search result from the external server.

Afterwards, the terminal 100 displays the subordinate concept search result on an area of the note screen in 680. The terminal 100 may display, together with the subordinate concept search result, a selection icon for selecting the subordinate concepts to be integrated into a note from the searched subordinate concepts.

Afterwards, the terminal 100 receives a subordinate concept selecting signal from a user, selects the subordinate concepts to be integrated into the note from the searched subordinate concepts, and integrates the selected subordinate concepts into the note in 690. For example, the terminal 100 may insert, into the note, the selected subordinate concepts in a graph form or in an indentation form.

The communicator 110, the input 120, the display 130, the storage 140, and the controller 150 in FIG. 1 and the text recorder 210, the text selector 220, the searcher 230, the clipper 240, and the note integrator 250 in FIG. 2 that perform the operations described with respect to FIGS. 1-6 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Functional programs, codes, and code segments for implementing the examples disclosed herein can be easily constructed by a programmer skilled in the art to which the examples pertain based on the drawings and their corresponding descriptions as provided herein.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of providing a search-integrated note function, the method comprising:
selecting a part of a text recorded in a note;
performing a web search with regard to the selected text;
clipping data selected by a user from a web search result;
linking the clipped data to the selected text; and
storing the clipped data.

2. The method of claim 1, wherein the performing of the web search comprises performing the web search using the selected text as a main search word and using at least one adjacent text of the selected text as an assistant search word.

3. The method of claim 2, wherein the adjacent text is a text recorded on the same note as the selected text.

4. The method of claim 1, wherein the performing of the web search comprises:
requesting a web server to perform the web search with respect to the selected text; and
receiving the web search result from the web server.

5. The method of claim 1, further comprising displaying the web search result on an area of a note screen.

6. The method of claim 1, further comprising searching, in response to a concept expansion command, one or more subordinate concepts with respect to the selected text; and
inserting the one or more searched subordinate concepts into the note.

7. The method of claim 6, wherein the searching of the one or more subordinate concepts comprises searching the one or more subordinate concepts based on an ontology built in advance.

8. The method of claim 6, wherein the inserting of the one or more searched subordinate concepts into the note comprises inserting, into the note, one or more subordinate concepts selected by the user from the one or more searched subordinate concepts.

9. A terminal comprising:
a text selector configured to select a part of text recorded in a note;
a searcher configured to perform a web search with respect to the selected text;
a clipper configured to clip data selected by a user from a web search result;
a storage configured to store the clipped data; and
a note integrator configured to link the clipped data to the selected text and store the clipped data.

10. The terminal of claim 9, wherein the searcher is further configured to perform the web search using the selected text as a main search word and using at least one adjacent text of the selected text as an assistant search word.

11. The terminal of claim 10, wherein the adjacent text is a text recorded in the same note as the selected text.

12. The terminal of claim 9, wherein the searcher is further configured to perform the web search by requesting a web server to perform the web search with respect to the selected text, and receiving the web search result from the web server.

13. The terminal of claim 9, further comprising a display configured to display a note screen;
wherein the searcher is further configured to display the web search result on an area of the note screen through the display.

14. The terminal of claim 9, wherein the searcher is further configured to search, in response to a concept expansion command, one or more subordinate concepts with regard to the selected text; and
the note integrator is further configured to insert the one or more searched subordinate concepts into the note.

15. The terminal of claim 14, wherein the searcher is further configured to search, in response to the concept expansion command, the one or more subordinate concepts based on an ontology built in advance.

16. The terminal of claim 14, wherein the note integrator is further configured to insert, into the note, one or more subordinate concepts selected by the user from the one or more searched subordinate concepts.
